(19) United States
(12) Patent Application Publication
(10) Pub. No.: US 2006/0153293 A1
(43) Pub. Date: Jul. 13, 2006

(54) Method for transcoding compressed data

(75) Inventors: Che-Kuei Hsu, Changhua City (TW); Yi-Kai Chen, Tainan City (TW)

Correspondence Address: KUSNER & JAFFE;HIGHLAND PLACE SUITE 310, 6151 WILSON MILLS ROAD, HIGHLAND HEIGHTS, OH, 44143, US

(73) Assignee: Ulead Systems, Inc.

(21) Appl. No.: 11/034,285

(22) Filed: Jan. 12, 2005

(51) Int. Cl. H04N 11/04; H04B 1/66; H04N 11/02; H04N 7/12

(52) U.S. Cl. 375/240.03; 375/240.23

(57) ABSTRACT

To control the bit rate, the de-quantization and quantization would spend a lot of valuable time. However, the bit rate would mainly depend on the level of quantization scale, so the bit rate could be controlled just through the manipulation of the quantization scale. The method of the present invention comprises steps of receiving a bitstream including the compressed data; performing variable length decoding (VLD) of the bitstream to obtain block data therein; multiplying the block data by a quantization scale ratio; and performing variable length coding (VLC) of the bitstream to generate the compressed data with the desired bit rate. With the method provided by the present invention, the transcoding process could be speedy and efficient without the performing of de-quantization and quantization steps.

### FIELD OF THE INVENTION

The present invention is related to a method for transcoding compressed data to modify the bit rate thereof, especially to a method for transcoding compressed audio/video data to reduce the bit rate thereof.

### BACKGROUND OF THE INVENTION

MPEG video compression is applied in many current and emerging products. It is at the heart of digital television set-top boxes, HDTV, DVD players, video conferencing, Internet video, and other applications. These applications may benefit from MPEG video compression in the fact that they may require less storage space for archived video information, less bandwidth for the transmission of the video information from one point to another or a combination of both. Besides, MPEG video compression is defined in two finalized international standards, MPEG-1 and MPEG-2, and a third standard currently in the definition process, MPEG-4. The acronym MPEG stands for Moving Picture Expert Group, which worked to generate the specifications under ISO, the International Organization for Standardization and IEC, the International Electrotechnical Commission.

Sometimes it is desired to reduce the bit rate of audio and video data, which saves storage and transmission costs. Different users have different storage and transmission capacities, however, as well as different quality requirements. Thus, for example, a Web site operator would like to be able to stream a video file previously compressed to 128 kilobits/second (“Kb/s”) to certain users at 64 Kb/s. A particular user might then recompress the 64 Kb/s video file to 32 Kb/s to save local storage space. In addition, different users can require different compression formats.

To control the bit rate, the compressor adjusts quantization based upon a rate-distortion function that relates distortion (and hence quantization) to bit rate. The compressor dynamically adjusts quantization to utilize available bit rate. Quantization helps the compressor reduce the bit rate of audio or video information at some cost to quality. The compressor can use various techniques to provide the best possible quality for a given bit rate.

Transcoding process converts compressed data of one bit rate or format to compressed data of another bit rate (typically lower) or format. Different transcoding processes use different techniques. Some transcoding processes fully decompress the compressed data and then fully recompress the data to the other bit rate or format. Other transcoding processes partially decompress the compressed data or convert the compressed data itself without decompression.

Heterogeneous transcoders use different formats for decompression and compression, for example, transcoding compressed MPEG 2 data to compressed H.261 data. Between decompression and compression, the data can be resampled or scaled into an acceptable input format for the compression. The resampling or scaling may require extensive processing, and can unnecessarily reduce quality. Moreover, this type of technique works when any of several available codecs can be used in a system, but is impractical or inconvenient for some real world applications. Homogeneous transcoders use the same format for decompression and compression.

Therefore, in order to change the bit rate, it is required to provide a simple and efficient way to transcode the source data.

### SUMMARY OF THE INVENTION

In view of the aforementioned problem, the present invention provides a method for transcoding compressed data to reduce the bit rate thereof rapidly. With the method according to the present invention, the transcoding of source data could be processed in a much more efficient and time-saving way, since the present invention leaves out the de-quantization, inverse scanning, quantization and scanning.

According to one purpose of the present invention, a method for transcoding compressed data is provided. Firstly, a bitstream including the compressed data which have been compressed by an encoder in advance is received, and the variable length decoding (VLD) is performed to obtain block data from the bitstream. Then, the block data would be multiplied by a quantization scale ratio to change the original bit rate of the source data to the desired bit rate. Finally, variable length coding (VLC) of the bitstream would be performed to encode the data.

According to another purpose of the present invention, a storage medium is provided. The storage medium has executable instructions for transcoding compressed data by performing following steps, which comprises: receiving a bitstream including the compressed data, which have been compressed by an encoder; performing variable length decoding (VLD) of the bitstream to obtain block data; multiplying the block data by a quantization scale ratio; and performing variable length coding (VLC) of the bitstream to generate the compressed data with the desired bit rate. The types of the storage medium may include the CD, the DVD, the Blu-ray disc, the floppy, the hard disc or the flash memory.

### BRIEF DESCRIPTION OF THE DRAWINGS

FIG. 1 is the flow chart showing the procedure of the method.

FIG. 2 is the block diagram of the storage medium.

### DETAILED DESCRIPTION OF THE PREFERRED EMBODIMENT

The present invention is described with the preferred embodiments and accompanying drawings. It should be appreciated that all the embodiments are merely used for illustration. Hence, the present invention can also be applied to various embodiments other than the preferred embodiments. Besides, the present invention is not limited to any embodiment but to the appending claims and their equivalents.

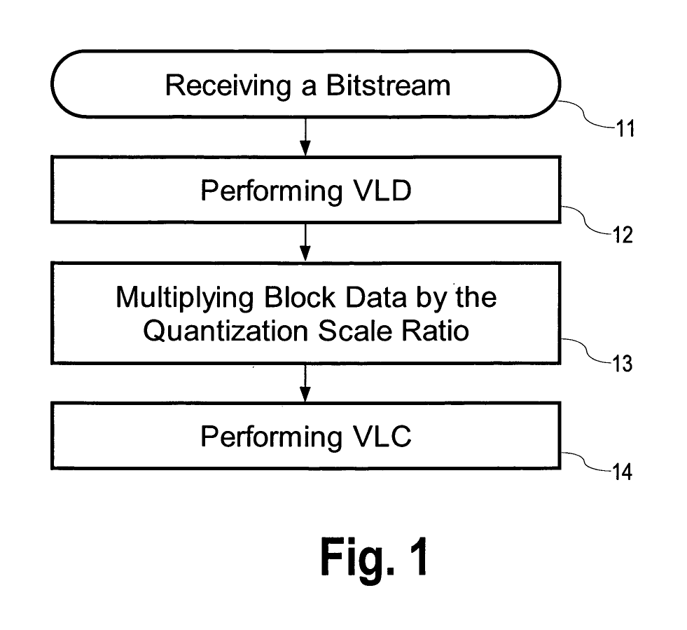

Referring to FIG. 1, a method for transcoding compressed data is illustrated. In the preferred embodiment of the present invention, the compressed data may be MPEG video data, but the method could still applied to any possible kinds of compressed data. First, a bitstream with the compressed data, namely MPEG video data, is received, as in step 11. Since the received data have been coded by certain encoder in advance, it is required to performing VLD (variable length decoding) of the bitstream to obtain the block data therein, as in step 12. After that, the conventional transcoder would perform de-quantization of the block data as shown in Formula 1, and this process, however, is always time-consuming.

$$\begin{matrix}{B}_{8 \times 8} \times S \times {Q}_{8 \times 8} = {B}_{8 \times 8}^{′} & Formula 1 \\ {B}_{8 \times 8}^{′} \times \frac{1}{{S}^{′} \times {q}_{8 \times 8}} = {B}_{8 \times 8}^{″} & Formula 2\end{matrix}$$

The Formulas 1 and 2 present the conventional procedure to transcode the block data. The B_{8×8} represents the 8×8 block matrix of compressed data, and the Q_{8×8} stands for the original 8×8 quantization matrix. As we can see in Formula 1, the block matrix is firstly de-quantized by performing the 8×8 matrix operation (Q_{8×8}) and multiplied by a parameter (S). Then, the de-quantized block matrix B′_{8×8} would be quantized again. As shown in Formula 2, the B′_{8×8} undergoes another 8×8 matrix operation

$$( \frac{1}{{q}_{8 \times 8}} )$$

and is divided by another parameter S′. The controlling of the bit rate mainly depends on the parameter S and S′, which are so-called quantization scales. In accordance with Formulas 1 and 2, this kind of transcoding should go through two times of 8×8 matrix operation as well as scanning or inverse scanning, and therefore would reduce the performance and cost considerable time.

$${B}_{8 \times 8} \times S \times {Q}_{8 \times 8} \times \frac{1}{{S}^{″} \times {q}_{8 \times 8}} = {B}_{8 \times 8} \times \frac{S}{{S}^{″}} = {B}_{8 \times 8} \times ratio \qquad Formula 3$$

The method of the present invention provides a new step to multiply the block matrix by a quantization scale ratio in order to replace the de-quantization step with inverse scanning and the quantization step with scanning. In Formula 3, the quantization matrix remains the same through whole transcoding process, namely, Q_{8×8} is identical to q_{8×8}. To control the bit rate, it only requires determining the desired quantization scale (S″), and then calculating the ratio of the original quantization scale (S) and the desired quantization scale (S″). It should be noted that the quantization scale ratio may be obtained by other possible ways or in consideration of certain demands. The division operation of quantization scales for calculating the ratio is merely described for illustration, instead of limitation. After the quantization scale ratio is obtained, the bit rate would be changed by multiplying the block data by the ratio, as shown in step 13. It should be noted that the calculation of the quantization scale ratio could be omitted by directly multiplying the block matrix by the original quantization scale (S) and dividing the block matrix by the desired quantization scale (S″) in sequence. The very same result would also be obtained.

Hence, the bit rate is controlled merely by adjusting the quantization scale. It should be noted that no matrix operation is necessary in the transcoding process, and therefore the performance would be highly increased and the process time would be extremely reduced. At last, the VLC (variable length coding) of the block data would be performed to stream the compressed data with the desired bit rate.

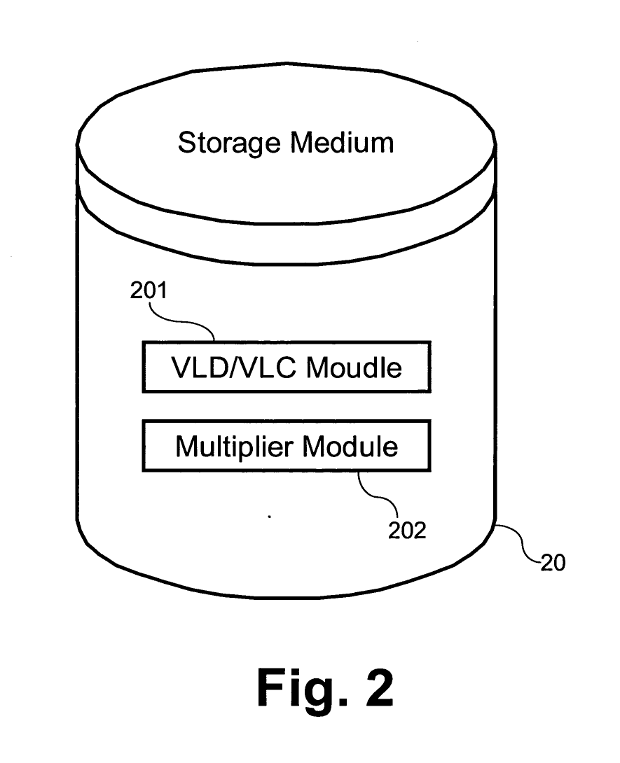

The present invention also provides a storage medium having executable instructions for transcoding compressed data. Referring to FIG. 2, the storage medium 20 is illustrated. As we can see, the storage medium merely requires few modules to transcode the source data, which are the VLD/VLC module 201 and the multiplier module 202. The modules may be certain software, a list of instructions, or even a circuit. Also, the types of the storage medium 20 may include the CD, the DVD, the Blu-ray disc, the floppy, the hard disc or the flash memory. It should be appreciated that the aforementioned types are merely enumerated for illustration, instead of limitation. The present invention could encompass all possible kinds of storage medium capable of keeping digital data.

First, the bitstream including compressed data, preferably MPEG video data, is received. The VLD/VLC module 201 then would perform VLD of the bitstream to obtain the block data therein. After that, the Multiplier module 202 would determine the desired quantization scale according to the desire bit rate. Besides, the Multiplier module 202 may also calculate the ratio of the original quantization scale and the desired quantization, namely the quantization scale ratio. Next, the block matrix would be multiplied by such quantization scale ratio by the Multiplier module 202, and the bit rate could be controlled without the process of de-quantization and quantization. It should be noted that the Multiplier module 202 may also be implemented as a divider or replaced by a divider module. That is, the Multiplier module 202 may be provided with the multiplication or the division function, and the present invention would encompass the multiplier or the divider applied as the Multiplier module 202. Additionally, the scanning and inverse scanning are also unnecessary. Finally, the VLD/VLC module 201 would perform VLC of the block data to stream the content therein, with the desired bit rate.

In conclusion, the present invention provides an efficient way to transcode the compressed data for controlling the bit rate thereof. In the transcoding process, only the quantization scale is changed, and the quantization matrix remains the same. Therefore, the present invention excludes the steps of de-quantization with inverse scanning and quantization with scanning. At least two times of matrix operations are omitted, and the time-consuming scanning and inverse scanning are also unnecessary. Through the ratio of the original and desired quantization scale, the bit rate is simply changed. Accordingly, the present invention surely makes a considerable progress of the bit rate controlling technique.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

We claim:

1. A method for transcoding compressed data, which comprises:
receiving a bitstream including said compressed data compressed by an encoder;
performing variable length decoding (VLD) of said bitstream to obtain block data;
multiplying said block data by a quantization scale ratio; and
performing variable length coding (VLC) of said bitstream to generate said compressed data with a desired bit rate.

2. The method as set forth in claim 1, wherein said quantization scale ratio is set by a user or obtained by dividing an original quantization scale by a desired quantization scale.

3. The method as set forth in claim 2, wherein said original quantization scale is retrieved upon the encoding of said compressed data.

4. The method as set forth in claim 2, wherein said desired quantization scale is determined according to said desired bit rate.

5. The method as set forth in claim 1, wherein said compressed data includes MPEG video data.

6. The method as set forth in claim 1, wherein said bitstream is transcoded without performing de-quantization and inverse scanning.

7. The method as set forth in claim 1, wherein said bitstream is transcoded without performing quantization and scanning.

8. A storage medium having executable instructions for transcoding compressed data by performing the following steps, which comprises:
receiving a bitstream including said compressed data compressed by an encoder;
performing variable length decoding (VLD) of said bitstream to obtain block data;
multiplying said block data by a quantization scale ratio; and
performing variable length coding (VLC) of said bitstream to generate said compressed data with a desired bit rate.

9. The storage medium as set forth in claim 8, wherein said quantization scale ratio is set by a user or obtained by dividing an original quantization scale by a desired quantization scale.

10. The storage medium as set forth in claim 9, wherein said original quantization scale is retrieved upon the encoding of said compressed data.

11. The storage medium as set forth in claim 9, wherein said desired quantization scale is determined according to a desired bit rate.

12. The storage medium as set forth in claim 8, wherein said compressed data includes MPEG video data.

13. The storage medium as set forth in claim 8, wherein said bitstream is transcoded without performing de-quantization and inverse scanning.

14. The storage medium as set forth in claim 8, wherein said bitstream is transcoded without performing quantization and scanning.

15. The storage medium as set forth in claim 8, wherein said storage medium includes a CD, DVD or Blu-ray disc.

16. The storage medium as set forth in claim 8, wherein said storage medium includes a floppy or a hard disc.

17. The storage medium as set forth in claim 8, wherein said storage medium includes flash memory.
